(19) United States
(12) Patent Application Publication
(10) Pub. No.: US 2002/0078366 A1
(43) Pub. Date: Jun. 20, 2002

(54) Apparatus and system for a virus-resistant computing platform

(76) Inventor: Joseph Raice, Spring Valley, NY (US)

Correspondence Address: Bernard Malina, Esq., 60 East 42nd Street, New York, NY, 10165-0501, US

(21) Appl. No.: 09/739,980

(22) Filed: Dec. 18, 2000

(51) Int. Cl. G06F 12/14

(52) U.S. Cl. 713/200

(57) ABSTRACT

An apparatus and related method are provided which control virus damage to a computer system by restricting access to disk drives. The apparatus includes a first disk drive containing a computer operating system and application programs, a second disk drive containing user data files, and a first and second switch. Both of the switches are operable between write-enabling and write-disabling states.

### BACKGROUND OF THE INVENTION

1. Field of the Invention

The invention relates to security systems for computers, particularly personal computers, and specifically to an apparatus and system for selectively disabling the write capability of disk drives.

2. The Related Art

Computers, and more specifically, personal computers and workstations, are subject to varying degrees of damage when infested by viruses or virus-like code elements. Damage can run the gamut from trivial, such as when a message is simply displayed on a monitor, to devastating, where the entire disk drive is corrupted or erased. Costs to businesses runs in the hundreds of millions of dollars annually in wasted employee time and lost business opportunity. The impact on consumers is also great, not the least of which is loss of confidence.

Malignant computer code segments (programs) written by rogue programmers and hackers are commonly known as viruses. These enter computers through a number of avenues, including infected diskettes, files downloaded from networks and web sites, e-mail attachments, and Word®, Excel®, and other program macros. They are usually hidden within legitimate-appearing programs or macros; when those are executed, they take control, replicate themselves, and wreak havoc. Generally, by the time their presence is detected, the damage is done.

Virus detection and correction programs provide some defense. They are limited in that their protection commences only after the virus has appeared, been analyzed, and updates to the anti-virus program received. However, new viruses are being written at a rate of several hundred per month, so there is constant risk of infection and damage.

Awareness on the part of the computer user, with constant vigilance helps to some extent to combat the problem. This requires that the user install only shrink-wrapped software, never open e-mail attachments received from untrusted parties, maintain a firewall in place, and shut off the computer when it is unattended. Unfortunately, these precautions, in addition to being cumbersome and annoying, also require severe restrictions on how the computer can be operated. For example, the Internet connection cannot be left “always on”, as provided by cable modems and DSL connections. Moreover, even these restrictions and precautions ultimately provide no guarantee of safety.

The relevant art includes U.S. Pat. No. 5,859,968 (Brown et al.) which describes a data security device for controlling access to an external data drive. An access controller selectively makes or breaks an electrical connection between the power supply and the external data drive to allow or prevent the addition and removal of data from the computer system using the external data drive. The access controller would include one or more switches that make or break an electrical connection to an external data drive. The access controller may include a multi-position lock that can be switched between multiple positions using a key. There is no disclosure in this reference regarding control of disk write-protection capability, utilization of multiple disk tiers, or of disk drives.

U.S. Pat. No. 5,552,776 (Wade et al.) describes an electronically controlled security system for controlling and managing access to computing devices. Selectively programmable access, monitored access, access privilege modification, and recorded access history are all provided within the security system.

U.S. Pat. No. 5,642,805 (Tefft) discloses an input device lock and method for preventing unauthorized access to a computer. The device is a lock switch that selectively enables or disables the line that effectuates data flow between an input device and the computer. When the flow-effectuating line is disabled by this device, no data is transmitted from the input device to the computer and, therefore, access to the computer is controlled. The lock switch is of a style that allows the key to be inserted or removed only when the lock switch is in the input device disabled state.

U.S. Pat. No. 6,009,518 (Shiakallis) reports on a computer system and method for storing distinct data types. The computer system includes a plurality of data storage devices. Selection of a data storage device activates and places the system in an operational mode. Upon selection of one of the data storage devices, the computer system implements a complete hardware reset in order to insure data from one storage device cannot be transferred to another.

U.S. Pat. No. 5,506,990 (Holman, Jr.) concerns a system for controlling the operation of computer power and reset switches. A separate key switch enables a user to selectively disable the power and reset switches of the computer. The user has the option of operating the computer in a secured mode, in which a user key is required to actuate the power and reset switches, or, alternatively, in an unsecured mode, in which the power and reset switches operate normally.

None of the foregoing art has directed attention to the problem of selectively disabling the write capability of disk drives nor to that of utilizing such capability in a system for providing virus damage protection.

Accordingly, it is an object of the present invention to provide an apparatus and system for selectively disabling the write capability of disk drives.

### SUMMARY OF THE INVENTION

The foregoing problem is solved, and a technical advance is achieved, by a system for managing the operation of the computer's disk drives such that their ability to write data to the disks is controlled. In a departure from the prior art, a separate key, toggle, or other type of switch enables a user to selectively disable the write-capability of a disk drive. The switch is exclusively manually operable; it cannot be switched between states by software of any kind. Virus protection is achieved by conforming to a set of procedures that make use of this ability.

A technical advantage achieved with the invention is its versatility in providing both unsecured (write-enabled) and secured (write-disabled) modes of operation at the option of the user.

A further technical advantage achieved with the invention is the ability to secure operating and application software against unauthorized modification by users in businesses and other organizations (achieved by leaving the key lock switch in the write-disabled state and not distributing the key).

A further technical advantage achieved is the relatively low cost associated with the manufacture and implementation of the invention in commercial computer products.

Accordingly, an apparatus for controlling virus damage to a computer system is provided which includes:

(i) a first disk drive containing a computer operating system and application programs;

(ii) a second disk drive containing the data files of an individual user;

(iii) a first switch manually operable between a write-enabling state and a write-disabling state communicating with and respectively leaving unprotected and protected the first disk drive; and

(iv) a second switch manually operable between a write-enabling state and a write-disabling state communicating with and respectively leaving unprotected and protected the second disk drive.

Optionally, there may be provided a third disk drive which does not communicate with any switch operable between write-enabling and write-disabling states.

The two or three disk drives are assembled in a multi-tiered arrangement. A method for restricting access to disk drives on a computer is also disclosed. The method includes utilizing the aforementioned apparatus in a procedure that selectively write-disables and write-enables the disk drives, as appropriate, through manually operating the switches between states.

### BRIEF DESCRIPTION OF THE DRAWING

The objects, features and embodiments of the present invention may be more fully appreciated through consideration of the following drawing, in which:

FIG. 1 depicts three disk drives, two of which are connected to two manually operated switches positioned for normal operational mode;

FIG. 2 is similar, except that the switches are positioned for on-line operational mode;

FIG. 3 is similar, except that the switches are positioned for software upgrade mode.

### DETAILED DESCRIPTION OF THE INVENTION

The problem addressed by the present invention has been solved through employment of a set of hardware modifications to personal computers and workstations coupled with a set of procedures that will virtually guarantee a computing environment and experience free of the ill effects of computer viruses. The essence of the concept is a disk storage system composed of at least two, preferably three tiers. The discrete disk drives are provided with varying types and levels of write-protection.

The first disk tier, which is the most highly protected, is intended for storing the operating system and all application (user) programs. In the preferred embodiment, the disk drive is write-enabled only when a key is manually inserted into a lock and turned to the “write enable” position. Movement to that position is done solely when installing new programs or program upgrades. Such program installation or upgrade would be performed only in offline mode; the Internet and any local area networks would be disconnected. Moreover, only trusted media, such as shrink-wrapped diskette, CD, DVD, and similar vehicles, would be utilized. An exception might be when downloading a program upgrade from a trusted source, but even this carries some risk. An extremely high degree of protection is thereby provided against infection, destruction or corruption to the critical operating system and application software.

The second disk tier is intended for storage of important user data, including accounting information, customer records, business data, manuscripts, spreadsheets, etc. In the preferred embodiment this disk drive is write-enabled only when a toggle switch is manually toggled to the “write-enable” position. The user would do this when running the programs that create or modify these types of data, and again only in offline mode. This provides solid protection against corruption or destruction of the user's data. Since both the first and second disk tiers are manual switch protected, no software, whether official or infiltrated, benign or malignant, is capable of write-enabling them. Only a user decision to manually turn the key or toggle the switch could effect that. The computer may be left constantly attached to the Internet without fear of virus infection. This permits the use of modem continuously connected cable-modem and DSL solutions. The third disk tier-the unprotected tier-is used for all non-critical and/or transient data, including downloaded programs and other information, such as bitmaps, pictures, music clips, and video segments. If a program or data set can be established to be “safe”—uninfected by a virus—it can subsequently be migrated to tier-2, or even to tier-1 (using the proper control procedure). If virus-containing code should lodge itself in tier-3, it would have very limited effect, at most, perhaps a message would be displayed or a sound generated. The virus would be unable to infect the operating and application software, and could be easily removed by “wiping” (completely erasing) the entire third tier disk drive. Even if a virus were to initiate and run a program residing on the tier-1 disk drive, that program would be unable to modify any of the programs on the first tier disk drive, or any of the data on the second tier disk drive. The reason being that neither the key lock switch nor the toggle switch would be in the write-enable position. In practice, it might be desirable to perform a complete tier-3 data purge at the end of every session that included any sort of exposure, whether through Internet or LAN access or downloading of data. Certainly the tier-3 disk drive would be purged prior to making any modifications to tier-1-based programs, and ordinarily before running any programs that modify tier-2-based data.

Switches of the present invention may be of any manually initiated type, including-but not limited to-manually operated mechanical key switch, toggle switch, rocker switch, pressure activated button switch, or manually triggered electro-mechanical or electronic switch (provided these last two are functionally isolated from the computer's operating and communication software and electronics).

Normal Operation Mode

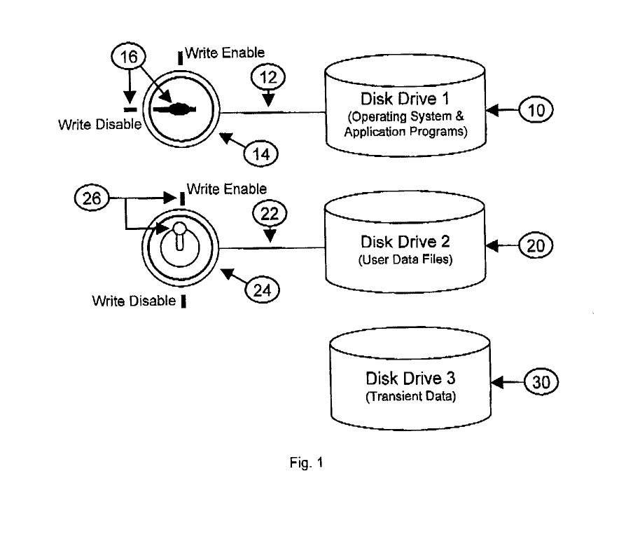

FIG. 1 illustrates the normal operational mode. A disk drive (10) contains operating system and application programs. An electrical connection (12) exists between the disk drive (10) and a key-operated switch (14), which is in the write-disable position (16). The operating system and application programs cannot be modified and are therefore protected.

A second disk drive (20) contains user data files. An electrical connection (22) exists between the disk drive (20) and a toggle switch (24), which is in the write-enable position (26). The user data files are therefore not write-protected; they can be modified by the appropriate programs, such as those for word-processing, accounting, and spreadsheets.

A third disk drive (30) is not generally utilized in normal operation mode; there is no provision for write-protecting it.

On-line Operation Mode

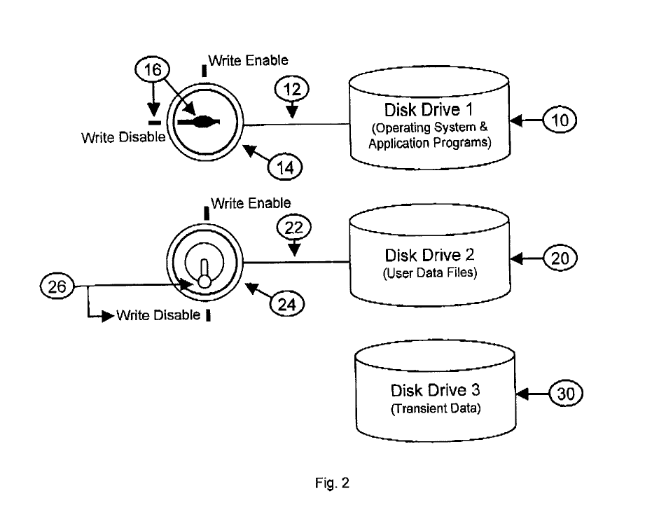

FIG. 2 illustrates the on-line operation mode. The disk drive (10), containing the operating system and application programs, is again connected to the key-operated switch (14) in the write-disable position (16), as in normal operation mode. In this mode, the operating system and application programs cannot be modified and therefore remain protected.

The second disk drive (20) containing the user data files again connects to the toggle switch (24), which is now, however, in the write-disable position (26). The user data files therefore also cannot be modified and are therefore also protected. In this manner, the FIG. 2 on-line operation differs from the FIG. 1 normal operational mode.

The third disk drive (30) is provided for temporary storage of transient data files accessed or downloaded during the on-line operation session; there is no provision for write-protecting it. It is recommended that for maximum protection, this disk drive (30) be wiped clean, with all files deleted, prior to write-enabling the disk drive containing the user data files (20) and thereby entering normal operational mode. It is vital that this disk drive (30) be wiped clean, with all files deleted, prior to write-enabling the disk drive containing the operating system and application programs (10) and thereby entering software install/upgrade mode.

Software Install/Upgrade Mode

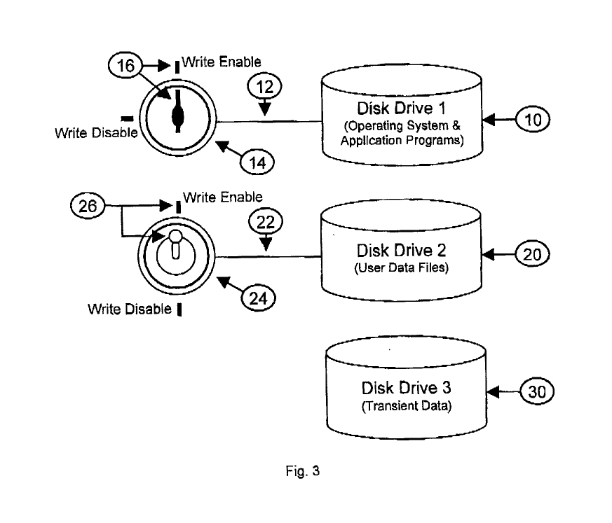

FIG. 3 illustrates the software install/upgrade mode. Here, the disk drive (10), containing the operating system and application programs, is once again connected to the key-operated switch (14), which, however, is now in the write-enable position (16). Operating system and application programs can now be installed or modified.

The second disk drive (20) containing the user data files connects to the toggle switch (24), which is once again in the write-enable position (26). The user data files therefore can be modified. This allows configuration files, preferences and other program-associated files to be installed or updated.

The third disk drive (30) is not utilized in software install/upgrade mode. Once again, it is critically important that this disk drive (30) be wiped clean, with all files completely erased, prior to entering software install/upgrade mode.

What is claimed is:

1. An apparatus for controlling virus damage to a computer system comprising:
(i) a first disk drive containing a computer operating system and application programs;
(ii) a second disk drive containing data files of an individual user;
(iii) a first switch manually operable between a write-enabling state and a write-disabling state communicating with and respectively leaving unprotected and protected the first disk drive; and
(iv) a second switch manually operable between a write-enabling state and a write-disabling state communicating with and respectively leaving unprotected and protected a second disk drive.

2. The apparatus according to claim 1 further comprising a third disk drive which does not communicate with any switch operable between write-enabling and write-disabling states.

3. The apparatus according to claim 1 wherein the first and second disk drives are disk drives.

4. The apparatus according to claim 1 wherein the first and second switches are selected from the group consisting of key-lock, toggle, rocker, push-button, fully isolated electro-mechanical and fully isolated electronic switches.

5. The apparatus according to claim 1 wherein the first and second disk drives are data drives within the computer system.

6. The apparatus according to claim 1 wherein the computer system comprises a housing into or onto which are mounted the first and second switches.

7. A method for restricting access to disk drives of a personal computer comprising:
providing a personal computer with a virus-resistant apparatus comprising:
(i) a first disk drive containing a computer operating system and application programs;
(ii) a second disk drive containing data files of an individual user;
(iii) a first switch manually operable between a write-enabling state and a write-disabling state communicating with and respectively leaving unprotected and protected the first disk drive; and
(iv) a second switch manually operable between a write-enabling state and a write-disabling state communicating with and respectively leaving unprotected and protected a second disk drive;
operating the first and second switches to the write-enabling and write-enabling states.
